(19) United States
(12) Patent Application Publication
(10) Pub. No.: US 2002/0098389 A1
(43) Pub. Date: Jul. 25, 2002

(54) High coercivity chp structural Co-based aloy longitudinal recording media and method for its fabrication

(76) Inventors: Jian Ping Wang, Cheu Chu (SG); Lea Peng Tan, Jurong East (SG); Ming Lang Yan, Lincoln, NE (US); Tow Chong Chong, Rendang (SG)

Correspondence Address: Rod S. Berman, Esq., JEFFER, MANGLS, BUTLER & MARMARO LLP, Tenth Floor, 2121 Avenue of the Stars, Los Angeles, CA, 90067, US

(21) Appl. No.: 09/518,710

(22) Filed: Mar. 3, 2000

(30) Foreign Application Priority Data
May 13, 1999 (SG) 9902226-1

(51) Int. Cl. G11B 5/66

(52) U.S. Cl. 428/694 TS

(57) ABSTRACT

The present invention provides improved magnetic recording media comprising a substrate, a non-magnetic underlayer, and a cobalt alloy based magnetic layer in a hexagonal closely-packed structure. An optional thin magnetic or non-magnetic intermediate layer is disposed between the magnetic layer and the substrate. The multilayer thin films of this invention are subjected to heat treatment after deposition. The multilayer films of this invention provide significant improvement in magnetic properties for longitudinal magnetic recording.

### FIELD OF THE INVENTION

The present invention relates to the structure of an improved thin film for magnetic recording media, and to significant improvement in magnetic properties afforded by post-deposition heat treatment during the fabrication of magnetic thin film media.

### BACKGROUND OF THE INVENTION

In the field of the magnetic recording, it is important to increase the recording density. In fact the recording densities of magnetic recording media have increased steadily over the last two decades.

A typical thin film disk has a multilayer structure including a substrate covered by an underlayer, a magnetic layer and optionally, an overlayer at the top. The magnetic bits of information are recorded in the magnetic layer. Currently, longitudinal recording media of cobalt alloy based magnetic films having a chromium or chromium alloy based underlayer deposited on a nonmagnetic substrate are the industry standard.

Magnetic properties, such as coercivity (H_{c}), remanent magnetisation thickness (Mᵣt) and coercive squareness (S^{≠}), are crucial to the recording performance of cobalt alloy based thin film media. For thin film longitudinal magnetic recording media, the desired crystalline structure of cobalt alloys is a hexagonal closely packed structure with uniaxial crystalline anisotropy and a magnetization [easy direction] wherein the z-axis is in plane of the film. The in-plane z-axis crystallographic texture determines the suitability of the cobalt alloy thin film for use in longitudinal magnetic recording.

When the magnetic grain size is small, the thin film media becomes thermally unstable. Thin films with larger grains have better thermal stability, but have a lower signal to noise ratio. Exchange coupling between magnetic grains also results in high media noise. Thus to achieve a high signal to noise ratio and a thermally stable magnetic medium, a cobalt alloy thin film should have uniform, small grains with grain boundaries that afford magnetic isolation from neighboring grains. This kind of microstructure and crystallographic texture is normally achieved by manipulating the deposition process.

The need for greater storage density demands hard disk media with higher coercivity. For example, to date, there have not been any published reports demonstrating coercivity sufficient to produce an areal density of 40 gigabits per square inch, based on the current hexagonal closely packed structure using cobalt alloy based thin film media.

The objective of the present invention is to fabricate longitudinal magnetic recording media with coercivity higher than 5000 Oersteds, low noise and good thermal stability.

### SUMMARY OF THE INVENTION

The object of the invention is satisfied by heat treatment of a magnetic recording medium comprising a substrate, a magnetic layer and an underlayer. In a preferred embodiment, an intermediate layer is interposed between the magnetic layer and the underlayer. In an especially preferred embodiment the magnetic layer is CoCrPt/Co and the intermediate layer is CoCrTa. The intermediate layer is relatively thin, preferably between 1 nm to 5 nm. The presence of an intermediate layer reduces the lattice strain within the magnetic layer such that the lattice constant of the magnetic layer can remain larger than that without intermediate layer. The argon pressure used for deposition of the intermediate layer may vary from 1 to 7 mTorr. Higher coercivity can be obtained when the argon pressure used during deposition of the intermediate layer approaches 7 mTorr. Further increase in coercivity can be obtained by post deposition annealing.

In another aspect of the present invention, heat treatment of cobalt alloy based longitudinal recording media will result in a significant improvement in coercivity and in improved signal to noise ratio. Grain size remains almost the same but grain isolation improves with heat treatment which, in turn results in a reduction of noise.

### BRIEF DESCRIPTION OF THE DRAWINGS

The advantages of the present invention can be better understood by reference to the drawings in which:

FIGS. 1(a) and (b) are the schematic illustrations of embodiments of a multilayer structure of the media structure of the present invention;

FIG. 2 shows the improvement in the coercivity after the addition of an intermediate layer;

FIG. 3 plots the changes in coercivity of CoCrPt/Cr magnetic layer as a function of CoCrTa intermediate layer thickness;

FIG. 4 shows the x-ray diffraction spectra of CoCrPt/Cr film with and without CoCrTa intermediate layer;

FIG. 5 plots the changes in coercivity of CoCrPt/Cr magnetic layer with different argon pressures during CoCrTa intermediate layer deposition;

FIG. 6 shows the x-ray diffraction spectra of CoCrPt/Cr film with CoCrTa intermediate layer deposited at different argon pressures;

FIG. 7 shows the time-of-flight secondary ion mass spectroscopy (TOF-SIMS) depth profile of CoCrPt/Cr thin film with CoCrTa intermediate layer deposited at 1 m Torr and 7 m Torr argon pressure;

FIG. 8 shows the improvement in the coercivity for a CoCrPt/Cr thin film with 2.6 nm of CoCrTa intermediate layer after the heat treatment;

FIG. 9 shows the improvement in coercivity after heat treatment of CoCrPt/Cr thin film media with CoCrTa intermediate layers ranging from 0 nm to 5 nm;

FIG. 10 shows the improvement in coercivity after heat treatment of CoCrPt/Cr thin film media with 2.6 nm of CoCrTa intermediate layer deposited with argon pressure ranging from 1 mTorr to 7 mTorr;

FIG. 11 shows the angular variation of as deposited CoCrPt/Cr film with and without CoCrTa intermediate layer;

FIG. 12 shows the angular variations of heat treated CoCrPt/Cr film with and without CoCrTa intermediate layer;

FIG. 13 shows the variation of magnetic viscosity with applied reverse field for both as deposited and heat treated CoCrPt/Cr film with 2.6 nm of CoCrTa intermediate layer;

### DETAILED DESCRIPTION OF THE PREFERRED EMBODIMENTS

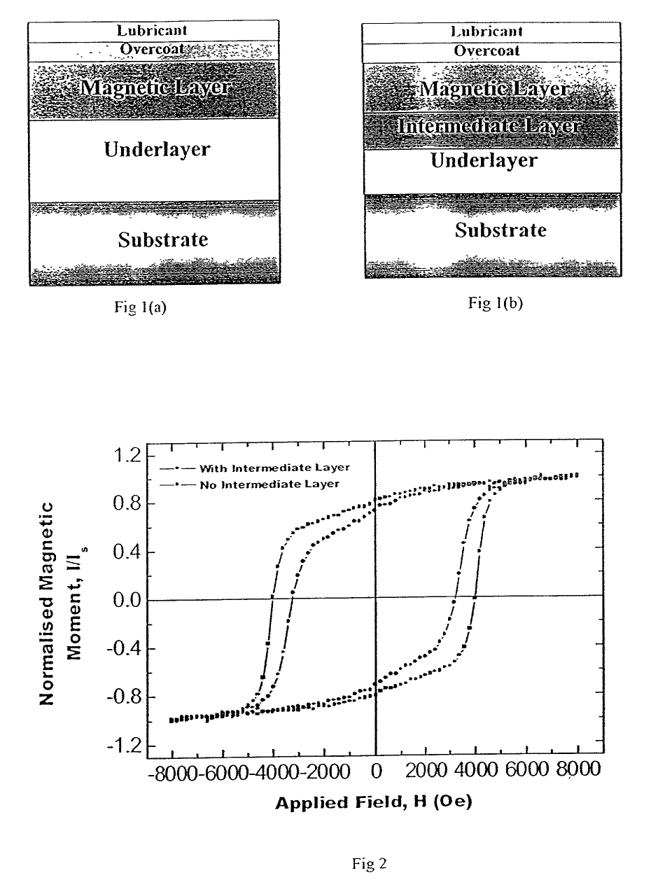

Referring to FIG. 1(a) and (b), the magnetic recording medium of the present invention comprises a substrate, an underlayer, and a magnetic layer. In a preferred embodiment an intermediate layer is deposited added between the underlayer and the magnetic layer. The intermediate layer may be magnetic or non-magnetic. In addition, there maybe an overcoat layer and a lubricant layer applied to the overcoat.

In the preferred embodiment, the thickness of the intermediate layer is 1 nm to 5 nm. The addition of an intermediate layer results in improvement in the magnetic properties of the thin film media of the present invention. The substrate may be glass or silicon. Alternative hard disk substrates such as ceramic glass, which is suitable for the heat treatment, may also be used. The magnetic layer is deposited with the longitudinal magnetic z-axis thereof substantially parallel to the plane of the magnetic film. The magnetic layer is preferably a cobalt or a cobalt based alloy, which is about 5 to 50 nm thick. The underlayer is preferably chromium or a chromium alloy or other know material with BCC, B2 or other crystallographic structure that can induce the magnetization orientation along either a perpendicular or longitudinal direction.

The preferred magnetic recording medium may be overcoat-free or it may include an overcoat with a thickness from 2 to 10 nm. The optional overcoat provides a mechanical wear layer and may be made of diamond-like carbon, ceramic material, SiO₂, SiC or ZrO₂ or any combination thereof. The lubricant which is on top of the overcoat is less than 2 nm thick and is preferably a fluoro-chlorocarbon or a perfluoroether.

In a preferred embodiment the media structure of the present invention is subjected to heat treatment. After deposition of metalic layers, the media is baked in an oven at temperatures that may range from 300° C. to 800° C. The time for heat treatment may range from 5 seconds to 30 minutes. Most preferably, the media structures are baked at 550° C. for one minute.

In order to compare the in-plane magnetic properties of the as-deposited and post heat treated magnetic recording medium of the present invention, 26 nm of CoCrPt magnetic layer, and a CoCrTa intermediate layer with a thickness varying from 0 nm to 5 nm, and a Cr underlayer were sputter-deposited upon a glass substrate using techniques well known to those skilled in the art. Direct-current (DC) sputtering was used for film deposition with substrate temperature at 300° C. and base pressure at 1×10⁻⁶ Torr. Argon pressure during sputtering was fixed at 1 mTorr for both the CoCrPt magnetic layer and the Cr underlayer; while the argon pressure during sputtering of the CoCrTa intermediate was varied from 1 mTorr to 7 mTorr. Two sets of samples were deposited. A first set of samples consisted of CoCrPt/Cr thin film media with the various CoCrTa intermediate layer thickness added. A second set of samples consisted of CoCrPt/Cr thin film media with a 2.6 nm of CoCrTa intermediate layer deposited with argon pressures ranges from 1 mTorr to 7 mTorr. Post deposition heat treatment, during which the temperature was set to 550° C. and held at this temperature for one minute, was performed on both sets of samples.

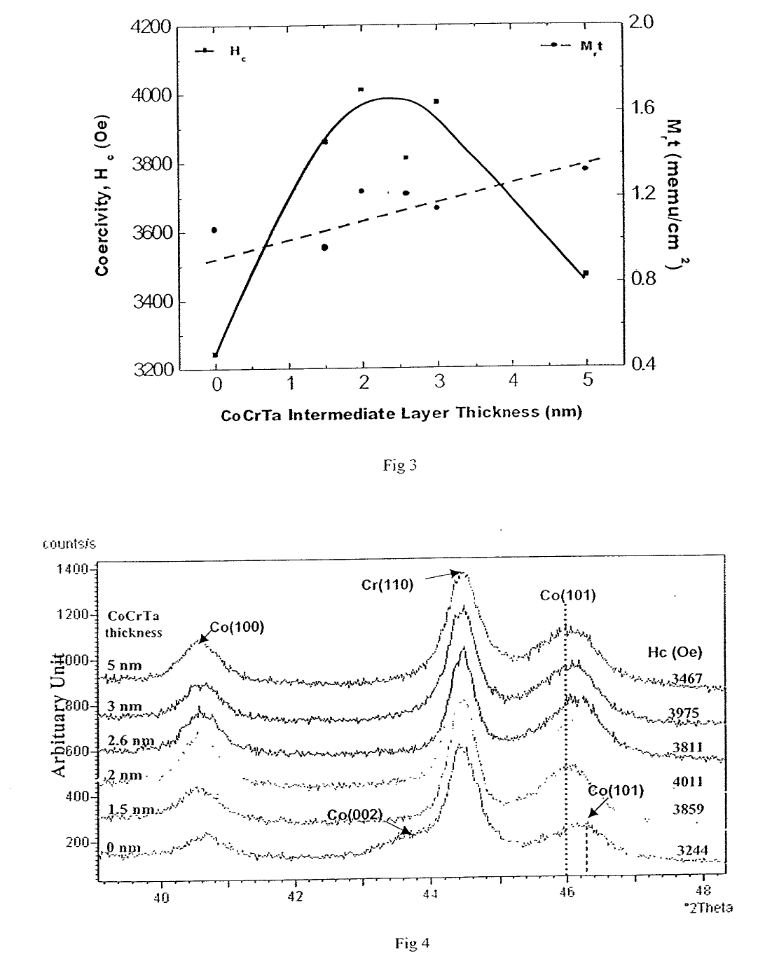

Improvement in coercivity (H_{c}) was observed when the CoCrTa intermediate layer was added as shown in FIG. 2. The variation of this improvement in (H_{c}) and Mᵣt as a function of CoCrTa intermediate layer thickness is shown in FIG. 3. Coercivity increases as the thickness of CoCrTa intermediate layer increases and reaches a peak value at about 2.5 nm. The highest coercivity observed was 5800 Oersteds. With further increase in the thickness of the CoCrTa intermediate layer thickness up to 5 nm, the coercivity was observed to decrease. The improvement in coercivity may be explained by the x-ray diffraction (XRD) spectrum which is shown in FIG. 4. Cobalt₍₁₀₁₎ peaks were shifted to a smaller angle when the intermediate layer was deposited. The addition of a CoCrTa intermediate layer is believed to reduce the lattice strain on the CoCrPt magnetic layer such that the lattice constant for CoCrPt can remain larger than that without intermediate layer. Further increase in the CoCrTa intermediate layer beyond 3 nm may result in lattice relaxation, which may explain the decrease in coercivity.

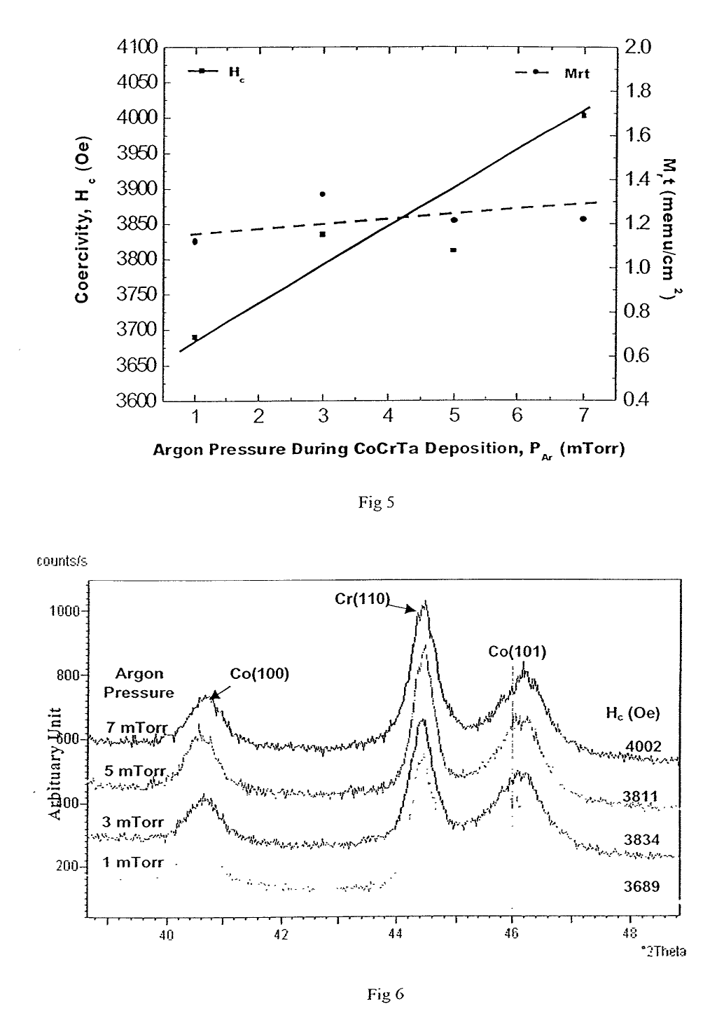

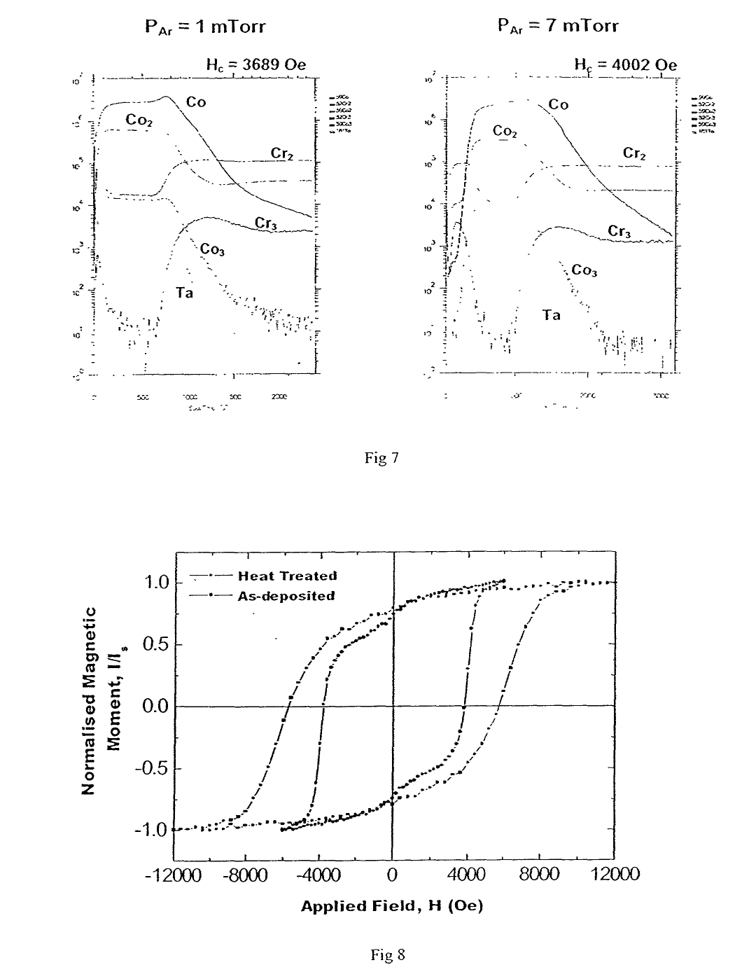

Increases in argon pressure during deposition of the CoCrTa intermediate layer also result in an increase in coercivity as shown in FIG. 5. The XRD spectra (FIG. 6) for the samples prepared with argon pressure ranging from lmTorr to 7 mTorr during deposition of the intermediate layer show that as argon pressure increases, the Cobalt₍₁₀₁₎ peaks shift towards a larger angle. Depth profiling by time-of-flight secondary ion mass spectropy (TOF-SIMS) was carried for two samples with argon pressure set at 1 mTorr and 7 mTorr for CoCrTa intermediate layer deposition. The result is shown in FIG. 7. It was found that the diffusion profile of Ta is larger as shown in the up and down slope for the sample with CoCrTa intermediate layer deposited at a higher argon pressure (i.e 7 mTorr) than that deposition with lower argon pressure (i.e. 1 mTorr). Thus grain isolation due to the diffusion of Ta from the CoCrTa intermediate layer to the grain boundary of the CoCrPt magnetic layer could be the explanation for the improvement in magnetic properties when higher argon pressure was used to deposit the CoCrTa intermediate layer.

Both sets of samples, that is one with the variation of CoCrTa intermediate layer thickness and another with the variation of CoCrTa intermediate layer deposition argon pressure, were heat treated. The temperature of the post deposition heat treatment was set to 550° C. and samples were held at this temperature for one minute. FIG. 8 shows the substantial increase in the coercivity after post-deposition heat treatment of CoCrPt/Cr thin film media with 2.6 nm of CoCrTa intermediate layer.

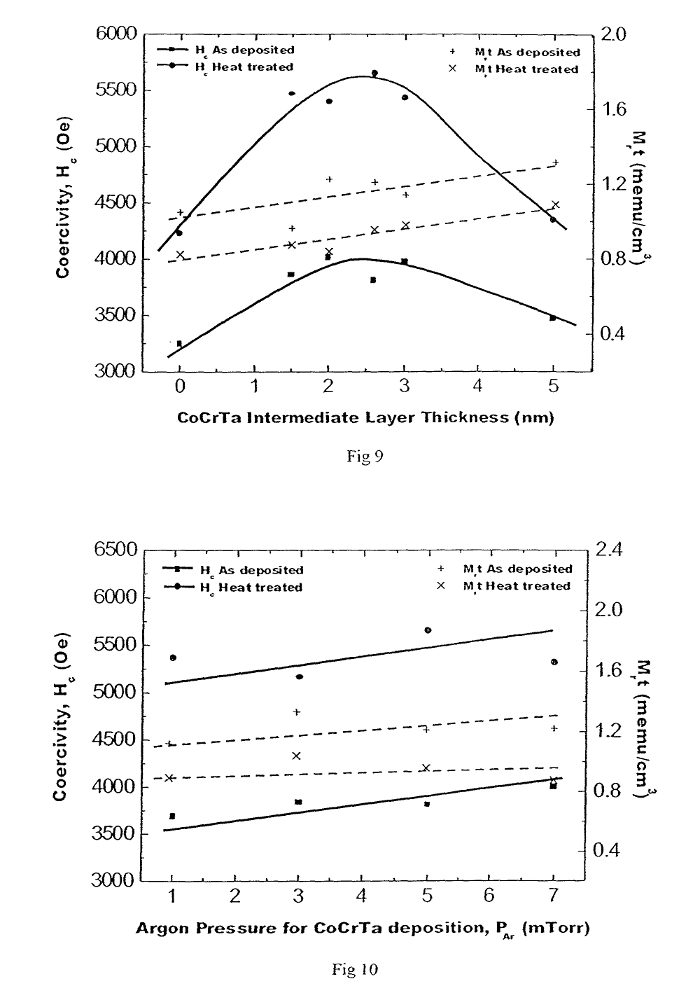

FIG. 9 shows the increase of coercivity after heat treatment of the CoCrPt/Cr thin film with various thicknesses of the CoCrTa intermediate layer. The trend of coercivity with CoCrTa intermediate layer thickness remains the same (i.e. H_{c} peaks at 2.5 nm of CoCrTa intermediate layer) while the coercivity improves significantly after heat treatment. Improvement in magnetic properties was also observed for CoCrPt/Cr thin film media prepared with a 2.6 nm CoCrTa intermediate layer deposited at different argon pressures after heat treatment was performed as shown in FIG. 10.

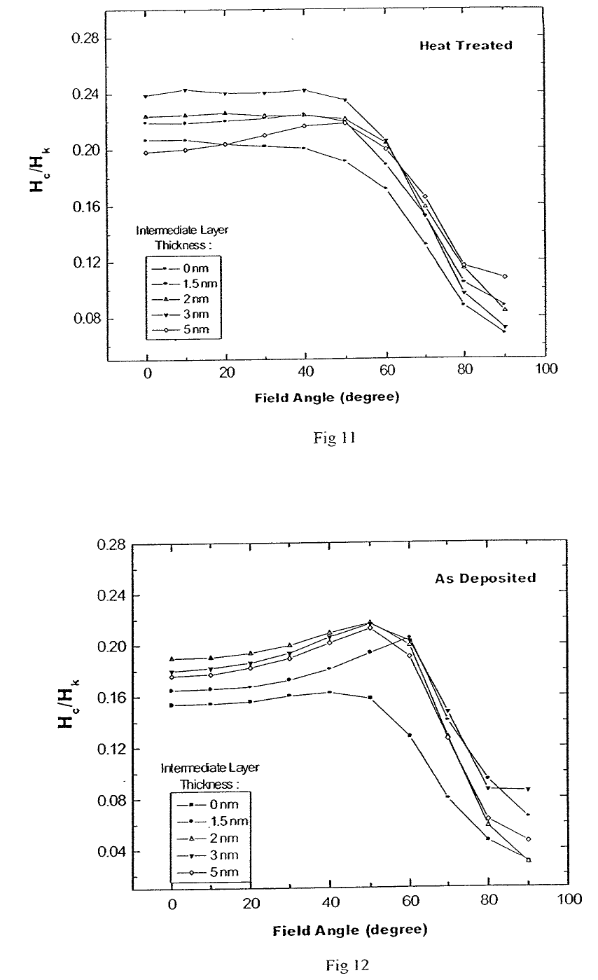

The angular variation of coercivity before and after heat treat of the CoCrPt/Cr thin film media with different CoCrTa intermediate layer thickness was also studied. FIG. 11 shows the angular variation of coercivity for as-deposited samples. The coercivity first increased, reached a peak value and then decreased as field angle approached 90° for a sample with a CoCrTa intermediate layer added. For the sample without a CoCrTa intermediate layer, no coercivity peak was observed. The occurrence of coercivity peaks for those samples with an intermediate layer implies the interaction among the grains. FIG. 12 show the angular variation of coercivity for heat treated samples. No coercivity peak was observed except for that with a 5 nm of CoCrTa intermediate layer added. This observation means that heat treatment will result in the reduction of interaction among the grains with a resulting reduction in media noise as well.

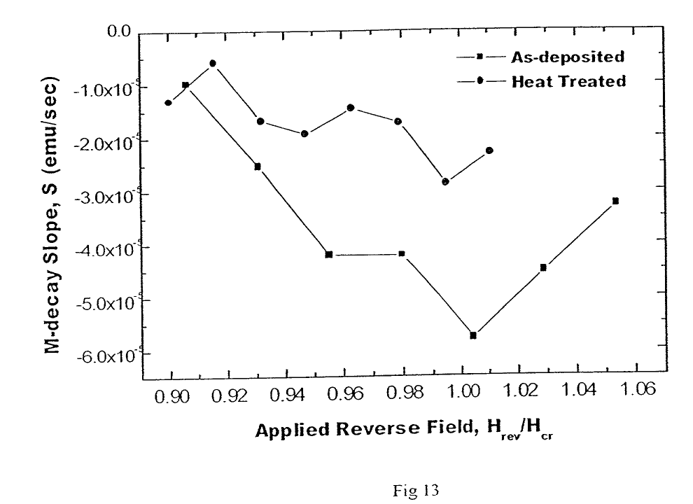

The magnetic viscosity coefficient of as deposited and heat treated CoCrPt/Cr thin film media with a 2.6 nm CoCrTa intermediate layer thickness were studied as shown in FIG. 13. It was found that the maximum magnetic viscosity coefficient of heat treated sample is much lower than that of as deposited sample. This implies that the thin film media will be more thermally stable after heat treatment.

It is anticipated that thin film longitudinal magnetic recording media fabricated with an intermediate layer and treated with the post deposition heating, will, with minor optimization, perform better than the comparable products without post deposition heat treatment or annealing:

It should be understood that the experimental observations described herein are for illustrative purposes only, and do not limit the scope of applicants' invention which is set forth in the claims appended hereto.

What is claimed is:

1. An improved thin film media structure for longitudinal magnetic recording comprising:
a substrate;
at least one underlayer in contact with the substrate;
at least one magnetic layer; and
at least one intermediate layer disposed between the underlayer and the magnetic layer;
wherein the thin film media structure receives heat treatment following deposition of the layers.

2. The improved media structure of claim 1 wherein heat treatment includes heating the media structure at a temperature ranging from 300 degrees C. to 800 degrees C.

3. The improved media structure of claim 2 wherein the media structure receives heat treatment for from 1 second to 30 minutes.

4. The improved media structure of claim 1 wherein the underlayer is selected from the group consisting of chromium, chromium alloy, and structures of BCC or B2 material.

5. The improved media structure of claim 4 wherein the chromium alloy is selected from the group consisting of CrV, CrMo, CrTi, CrW and CrTiB.

6. The improved media structure of claim 1 wherein the thickness of the underlayer is from 5 nm to 200 nm.

7. The improved media structure of claim 1 wherein the magnetic layer is cobalt or a cobalt based alloy of from 5 nm to 50 nm in thickness.

8. The improved media structure of claim 7 wherein the cobalt based alloy comprises chromium or platinum, and is deposited on chromium.

9. The improved media structure of claim 1 wherein the intermediate layer CoCrTa and from 1 nm to 5 nm in thickness.

10. The improved media structure of claim 1 wherein the intermediate layer is deposited in an argon atmosphere.

11. The improved media structure of claim 10 wherein the partial pressure of argon is from 1 mTorr to 20 mTorr.

12. The improved media structure of claim 1 further comprising an overcoat selected from the group consisting of carbon, ceramic material, silicon dioxide, silicon carbide, or zirconia.

13. The improved media structure of claim 12 wherein the overcoat is from 2 to 10 nm in thickness.

14. The improved media structure of claim 1 wherein the intermediate layer is disposed between two magnetic layers.

15. The improved media structure of claim 8, wherein the cobalt based alloy is doped with Ta, W, Si, B, Ni, Ti, Al, or Mn.

16. The improved media structure of claim 1 wherein the intermediate layer may be magnetic or non-magnetic.

17. The improved media structure of claim 1 wherein the intermediate layer is an alloy selected from the group consisting of cobalt, titanium, chromium, tantalum, nickel and aluminum.
